(19) United States
(12) Patent Application Publication
(10) Pub. No.: US 2008/0030903 A1
(43) Pub. Date: Feb. 7, 2008

(54) Suspension having stress absorbing structure, head gimbal assembly and disk drive unit with the same

(75) Inventor: Xianwen Feng, DongGuan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/498,198

(22) Filed: Aug. 3, 2006

(51) Int. Cl. G11B 5/48

(52) U.S. Cl. 360/245.7; 360/245.9

(57) ABSTRACT

A suspension for a head gimbal assembly comprises a flexure having a suspension tongue formed at its one end along length direction thereof for mounting a slider thereon. The suspension tongue has at least one partially hollowed stress absorbing structure for absorbing stress generated on the suspension tongue. The stress absorbing structure may include a notch formed on perimeter of the suspension tongue or a cutout formed in the suspension. The invention also discloses a head gimbal assembly and a disk drive unit with the same.

### FIELD OF THE INVENTION

The present invention relates to information recording disk drive devices and, more particularly, to a suspension having stress absorbing structure, head gimbal assembly and disk drive unit with the same.

### BACKGROUND OF THE INVENTION

One known type of information storage device is a disk drive device that uses magnetic media to store data and a movable read/write head that is positioned over the media to selectively read from or write to the disk.

FIGS. 1a and 1b illustrate a conventional disk drive device and show a magnetic disk 101 mounted on a spindle motor 102 for spinning the disk 101. A voice coil motor arm 104 carries a head gimbal assembly (HGA) 100 that includes a slider 103 incorporating a read/write head. A voice-coil motor (VCM, not labeled) is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103, incorporating the read/write transducer, and the spinning magnetic disk 101. The lift force is opposed by equal and opposite spring forces applied by the HGA 100 such that a predetermined flying height above the surface of the spinning disk 101 is maintained over a full radial stroke of the motor arm 104.

Now referring to FIGS. 1c-1e, a conventional HGA 100 comprises a slider 103 having a reading/writing transducer imbedded therein, a suspension 290 to load or suspend the slider 103 thereon. As illustrated, the suspension 290 includes a load beam 106, a base plate 108, a hinge 107 and a flexure 105, all of which are assembled together.

The load beam 106 is connected to the base plate 108 by the hinge 107. A locating hole 112 is formed on the load beam 106 for aligning the load beam 106 with the flexure 105. As best shown in FIG. 1e, a dimple 111 is formed on the load beam 106 to transfer load forces generated by the load beam 106 to the flexure 105 at a position corresponding to a center of the slider 103. By this engagement of the dimple 111 with the flexure 105, the load forces can be transferred to the slider 103 uniformly, thus making the slider 103 working more stably.

The base plate 108 is used to enhance structure stiffness of the whole HGA 100. A mounting hole 113 is formed on end of the base plate 108 for mounting the whole HGA to the motor arm 104 (refer to FIGS. 1a-1b). The hinge 107 has a mounting hole 110 formed on its one end corresponding to the mounting hole 113 of the base plate 108, and the hinge 107 is partially mounted to the base plate 108 with the mounting holes 110, 113 aligned with each other. The hinge 107 and the base plate 108 may be mounted together by laser welding at pinpoints 109 distributed on the hinge 107. Two hinge steps 115 are integrally formed at two sides of the hinge 107 at one end adjacent the mounting hole 110 for strengthening stiffness of the hinge 107. In addition, two hinge struts 114 are extended from the other end of the hinge 107 to partially mount the hinge 107 to the load beam 106.

The flexure 105 is made of flexible material and runs from the hinge 107 to the load beam 106. The flexure 105 has a proximal end 119 adjacent the hinge 107 and a distal end 118 adjacent the load beam 106. A locating hole 117 is formed on the distal end 118 of the flexure 105 and aligned with the locating hole 112 of the load beam 106, thus obtaining a high assembly precision. A suspension tongue (also known as a gimbal) 116 is provided at the distal end of the flexure 105 to carry the slider 103 thereon.

FIG. 1f shows a more detailed structure of the flexure 105. As illustrated in the figure, a plurality of suspension traces 120 is formed on the flexure 105 along length direction thereof. One end of the traces 120 is electrically connected to a preamplifier (not shown), and the other end thereof extends into the suspension tongue 116. When the slider 103 is mounted on the suspension tongue 116 and electrically coupled with the other ends of the traces 120, the preamplifier controls the slider 103, thus realizing data reading/writing operation with respect to the disk. The suspension tongue 116 is supported by a pair of cross bars 122 extending from two lateral sides thereof respectively. The cross bars 122 are further connected to a pair of struts 121 respectively, which are formed at distal end of the flexure 105. The suspension tongue 116 has a leading edge limiter 123 provided at one end thereof and a trailing edge limiter 124 provided at the other end thereof for stably holding the slider 103 on the suspension tongue 116. Furthermore, a pair of grounding pads 125 is provided on the suspension tongue 116 adjacent the leading edge limiter 123 to prevent ESD (electric static discharge) problem.

In a common disk drive unit, the slider flies only approximately a few micro-inches above the surface of the rotating disk. Generally, the flying height of the slider is considered as one of the most critical parameters affecting the disk reading and writing performances. More concretely, a relatively small flying height allows the transducers impeded on the slider to achieve a greater reading/writing resolution between different data bit locations on the disk surface, thus improving data storage capacity of the disk. Therefore, it is desired that the slider have a very small flying height to achieve a higher data storage capacity. At the same time, with the increasing popularity of lightweight and compact notebook type computers that utilize relatively small yet powerful disk drives, the need for a progressively lower and lower flying height has continually grown.

With reduction of the flying height, it is strongly expected that the flying height be kept constant all the time regardless of variable flying conditions, since great variation of flying height will deteriorate reading/writing performance of the slider, and in worse cases even result in data reading/writing failure. One of the facts that cause variation of flying height is thermal deformation of the suspension tongue. Specifically, when subjected to strong temperature changes, the suspension tongue will expand or contract, thus making the profile of the slider mounted thereon also deformed, and finally resulting in variation of the flying height. The flying height variation further badly affects the reading/writing performance of the slider. Therefore, it is necessary to control the deformation to a tolerant limit. However, in structure of the conventional suspension described above, since no special structure is provided on the suspension tongue to prevent or reduce deformation of the suspension tongue, great variation of flying height always exists, which degrades flying performance of the slider, as well as data reading/writing performance thereof.

Thus, there is a need for an improved suspension, head gimbal assembly, and disk drive unit that do not suffer from the above-mentioned drawbacks.

### SUMMARY OF THE INVENTION

One aspect of the present invention is to provide a suspension for a head gimbal assembly that can reduce variation of flying height of a slider, thus improving flying performance thereof.

Another aspect of the present invention is to provide a head gimbal assembly that can reduce variation of flying height of a slider, thus improving flying performance thereof.

Yet another aspect of the present invention is to provide a disk drive unit that can reduce variation of flying height of a slider, thus improving flying performance of the slider, and further improving data reading/writing performance of the disk drive unit.

To achieve above objects, a suspension for a head gimbal assembly comprises a flexure having a suspension tongue for mounting a slider thereon. The suspension tongue has at least a stress absorbing structure for absorbing stress generated on the suspension tongue.

Preferably, the stress absorbing structure is a partially hollowed structure. In an embodiment, the stress absorbing structure is a notch formed on perimeter of the suspension tongue. In another embodiment, the stress absorbing structure includes a plurality of notches which are symmetrical about a longitudinal centerline of the suspension tongue. The notch may extend along a horizontal direction of the suspension tongue. The symmetrical design of the notches helps to absorb the stress uniformly and accordingly reduce thermal deformation of the suspension tongue.

In another embodiment, the stress absorbing structure is a cutout formed in the suspension tongue. In addition, the cutout has a curved portion for improving stress-absorbing performance of the suspension.

Alternatively, the stress absorbing structure may also be a plurality of cutouts which are symmetrical about a position of the suspension tongue corresponding to a center of the slider being mounted. Of course, in another embodiment, these cutouts may be symmetrical about a longitudinal centerline of the suspension tongue. The symmetrical design of the cutouts helps to absorb the stress uniformly and accordingly reduce thermal deformation of the suspension tongue.

A head gimbal assembly comprises a suspension and a slider supported by the suspension. The suspension comprises a flexure having a suspension tongue. The suspension tongue has at least one stress absorbing structure for absorbing stress generated on the suspension tongue. The slider is carried on the suspension tongue of the flexure.

A disk drive unit comprises a head gimbal assembly including a slider and a suspension that supports the slider; a drive arm connected to the head gimbal assembly; a disk; and a spindle motor operable to spin the disk. The suspension comprises a flexure having a suspension tongue. The suspension tongue has at least one stress absorbing structure for absorbing stress generated on the suspension tongue. The slider is carried on the suspension tongue of the flexure.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a perspective view of a conventional disk drive unit;

FIG. 1b is a partial perspective view of the disk drive unit shown in FIG. 1a;

FIG. 1c is a perspective view of a conventional head gimbal assembly (HGA);

FIG. 1d is an exploded, perspective view of the HGA shown in FIG. 1c;

FIG. 1e is a partial side view of the HGA shown in FIG. 1c;

FIG. 1f is a partial top plan view of the flexure shown in FIG. 1c;

FIG. 2a is an exploded, perspective view of a suspension according to an embodiment of the invention;

FIG. 2b is a partial top plan view of a flexure of the suspension shown in FIG. 2a;

FIG. 3a shows a partial side view of a conventional HGA, illustrating a big thermal deformation in crown of the slider;

FIG. 3b shows a partial side view of a HGA incorporating a suspension of the invention, illustrating a small thermal deformation in crown of the slider;

FIG. 4a shows a partial side view of a conventional HGA and a disk, illustrating a big flying height variation;

FIG. 4b shows a partial side view of a HGA incorporating a suspension of the invention and a disk, illustrating a relatively small flying height variation;

FIG. 5a shows a partial side view of a conventional HGA and a disk, illustrating a big turbulent air flow generated between the slider and the disk;

FIG. 5b shows a partial side view of a HGA having a suspension of the invention and a disk, illustrating a small turbulent air flow generated between the slide and the disk;

FIG. 6a shows a partial top plan view of a flexure according to another embodiment of the invention;

FIG. 6b shows a partial top plan view of a flexure according to a further embodiment of the invention;

FIG. 6c shows a partial top plan view of a flexure according to yet another embodiment of the invention;

FIG. 7 shows a perspective view of a HGA incorporating a suspension of the invention; and

FIG. 8 shows a perspective view of disk drive unit according to an embodiment of the invention.

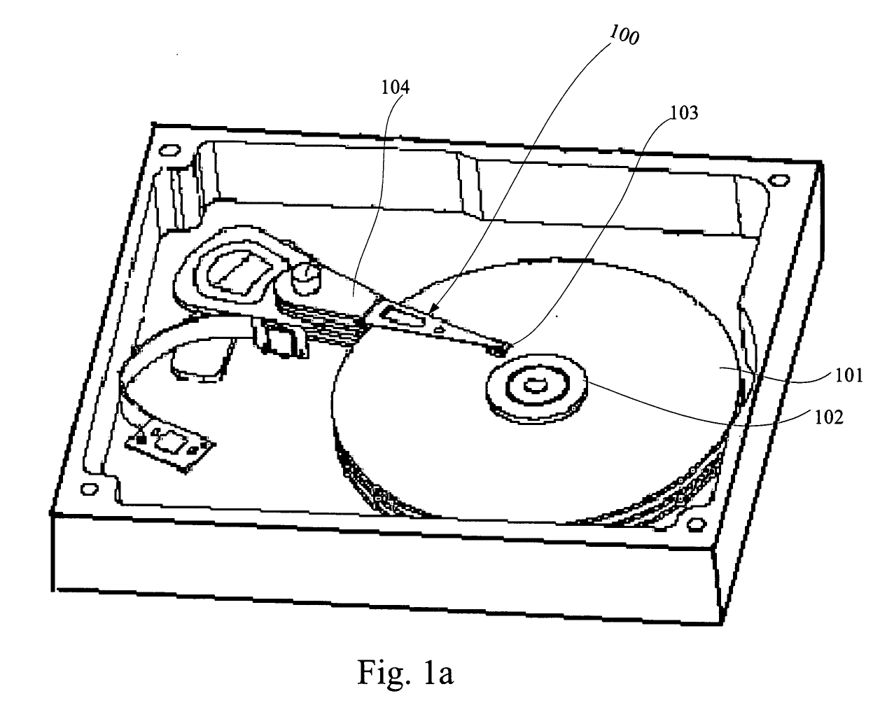

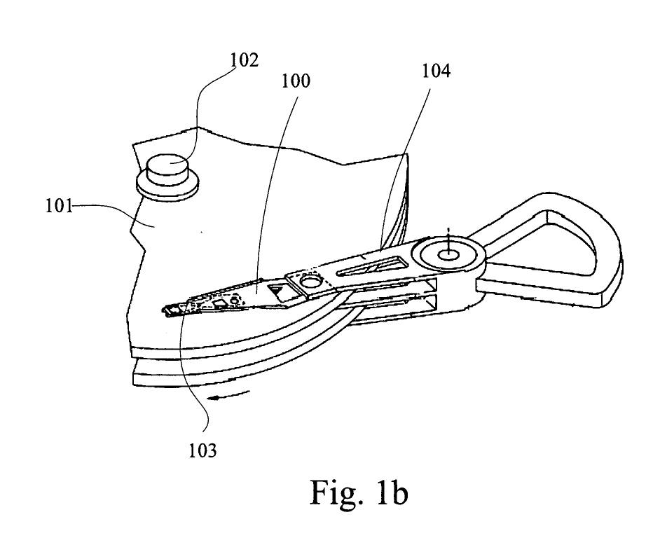

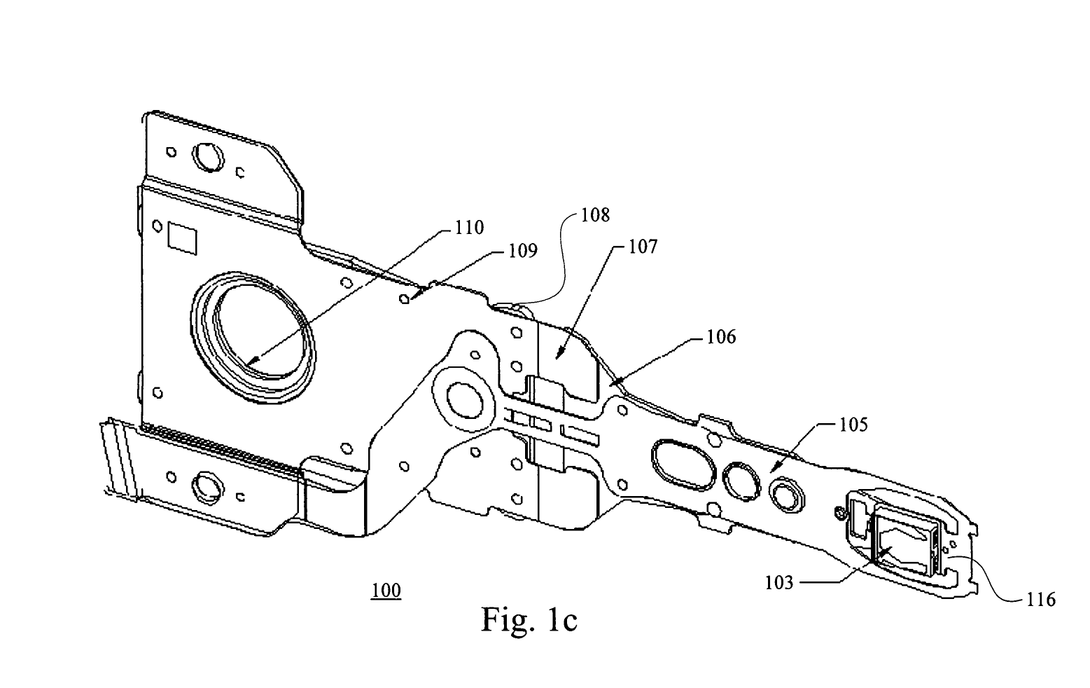

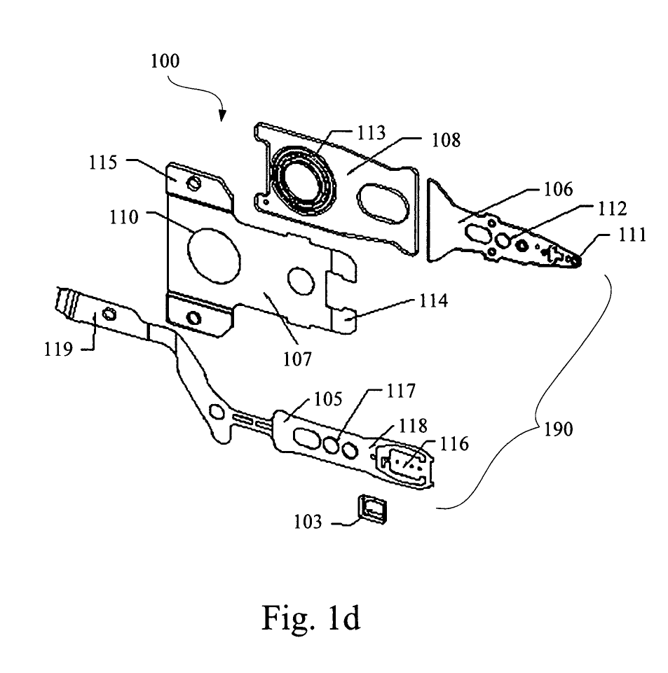

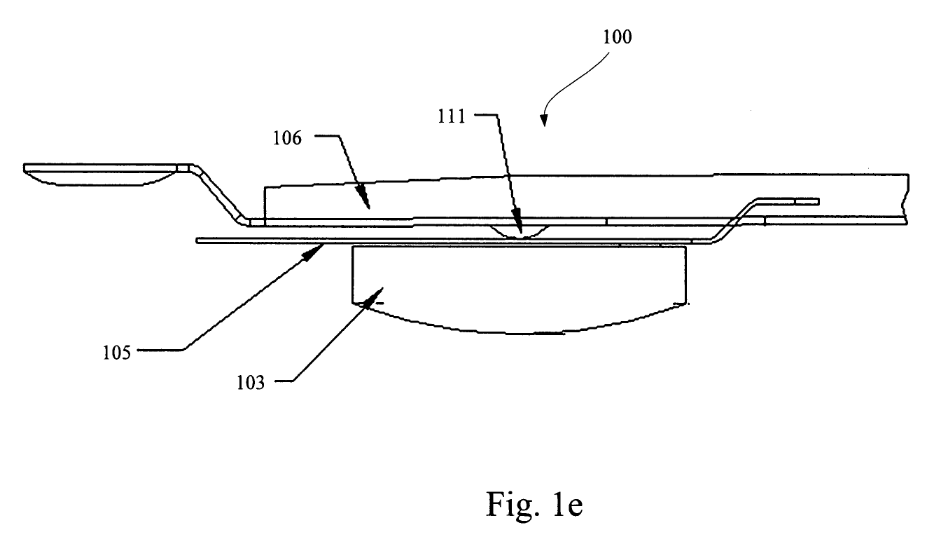

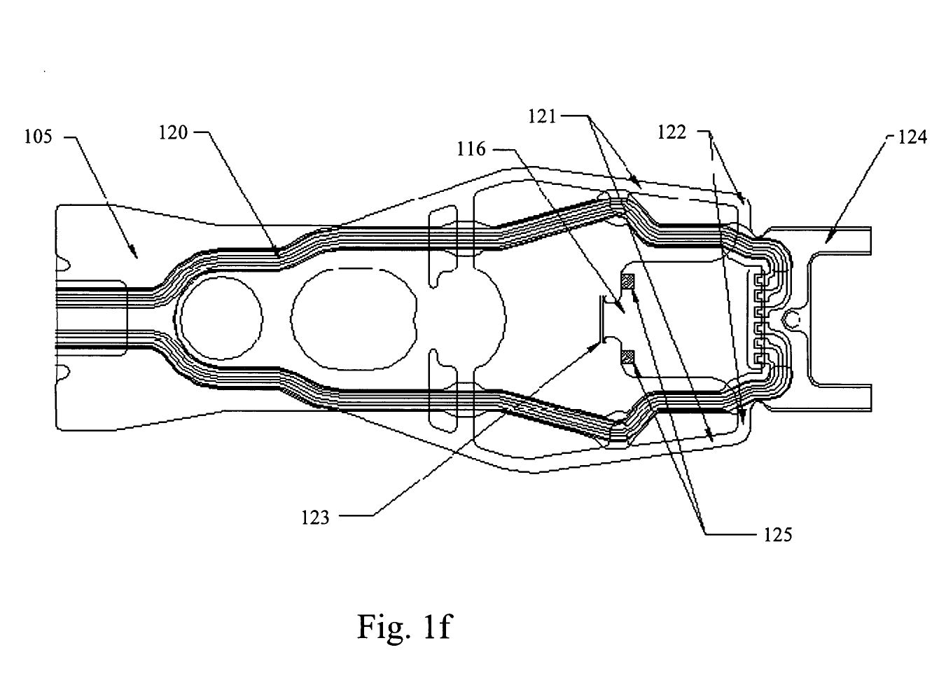

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a suspension for a head gimbal assembly of a disk drive unit, which comprises a flexure having a suspension tongue formed at its one end along length direction thereof for mounting a slider thereon. The suspension tongue has at least one stress absorbing structure. By forming the stress absorbing structure on the suspension tongue, the thermal deformation thereof due to temperature change is prevented or reduced greatly, thus preventing or reducing deformation of the slider, improving flying stability of the slider, and finally improving reading/writing characteristics of the slider and performance of entire disk drive device.

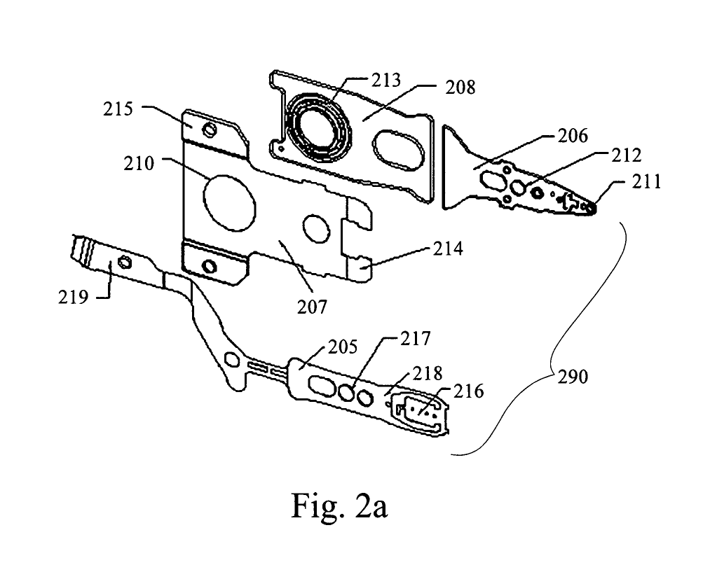

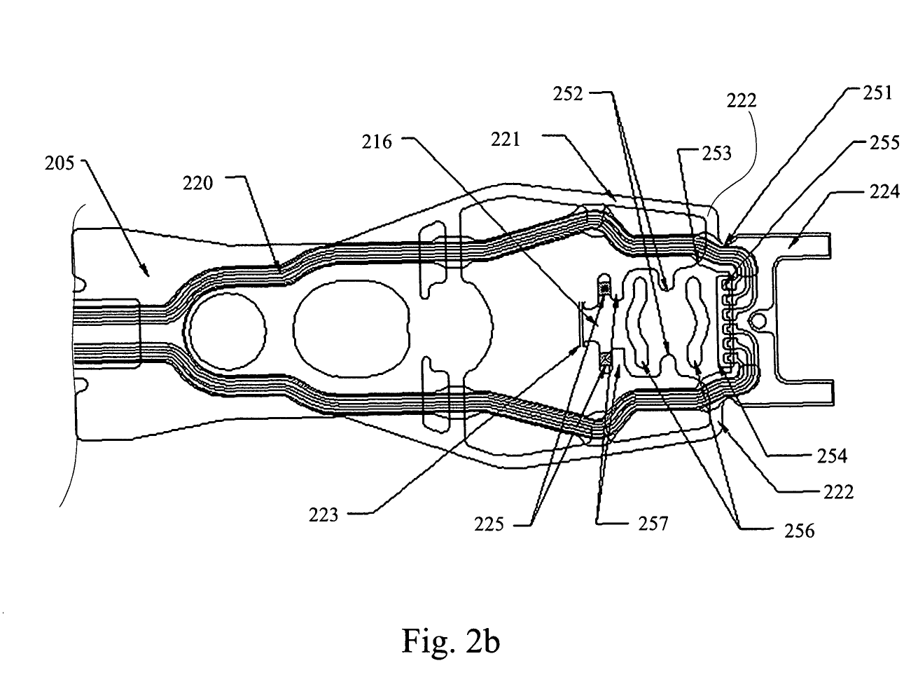

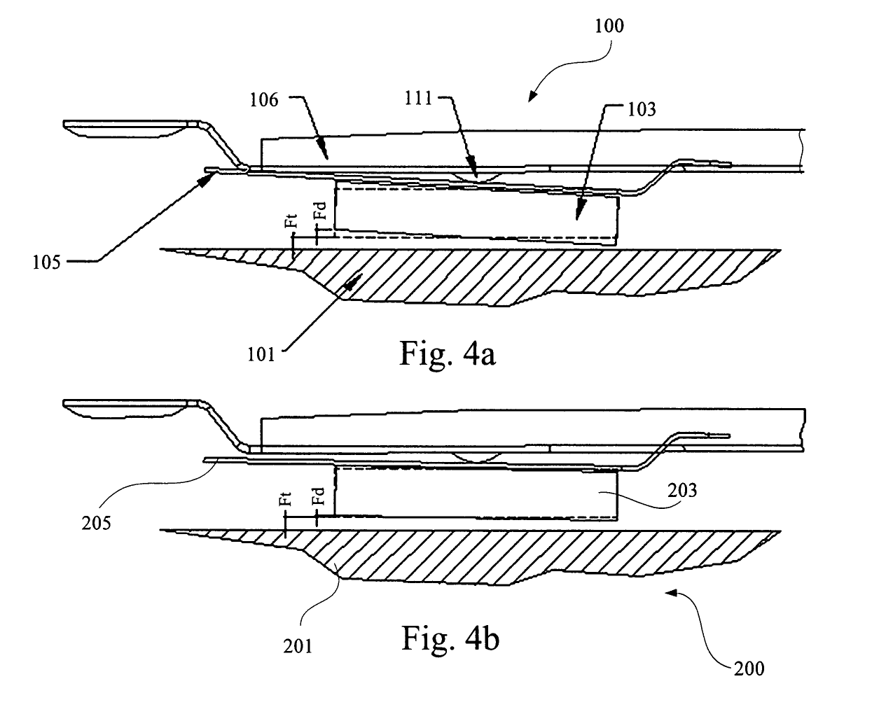

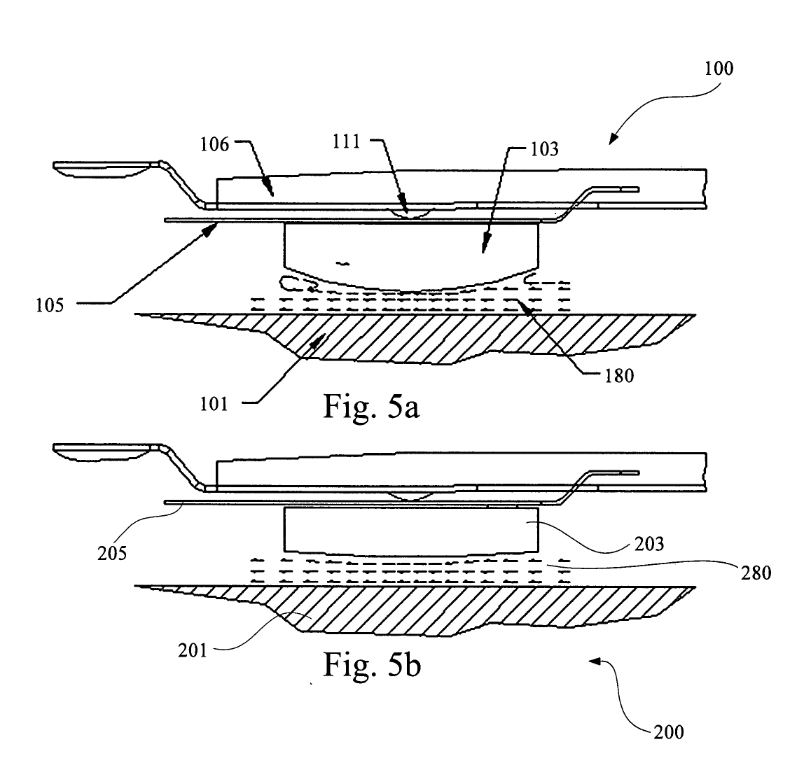

FIGS. 2a-5b show an embodiment of the invention. As illustrated in FIG. 2a, the suspension 290 comprises a load beam 206, a base plate 208, a hinge 207 and a flexure 205, all of which are assembled with each other.

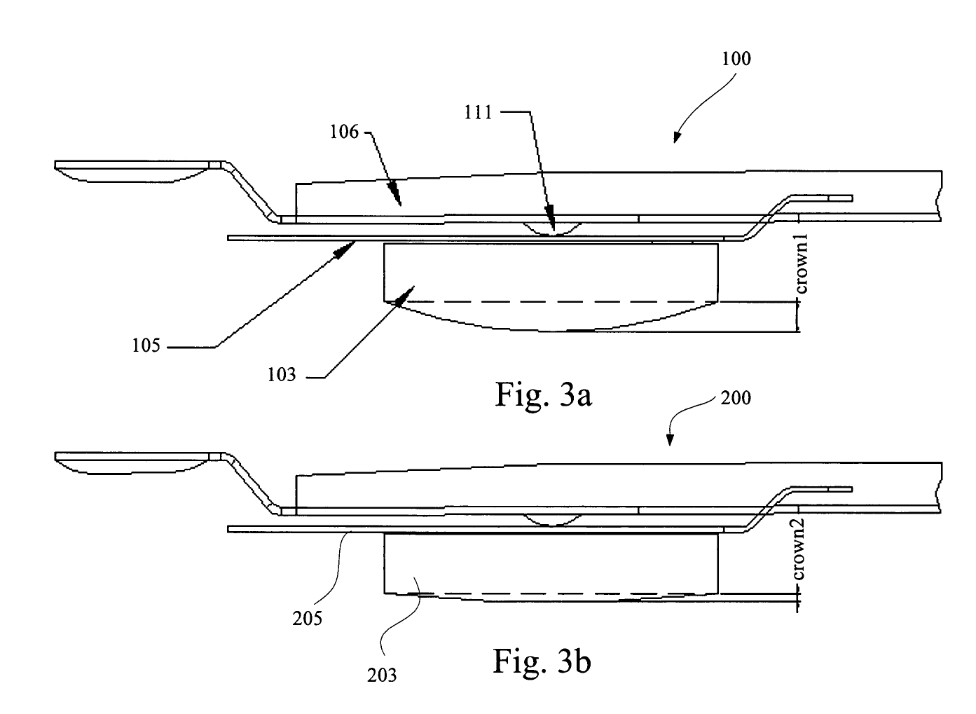

The load beam 206 is used to transfer load forces to the flexure 205 and a slider 203 mounted on the flexure 205 (refer to FIG. 3b). Any suitable rigid material such as stainless steel may be used to form the load beam 206, such that the load beam 206 has sufficient stiffness to transfer the load forces to the flexure 205. The load beam 206 is connected to the base plate 208 by the hinge 207. A locating hole 212 is formed on the load beam 206 for aligning itself with the flexure 205. As best shown in FIG. 3b, a dimple 211 is formed on the load beam 206 to support the flexure 205 at a position corresponding to a center of the slider 203. By this engagement of the dimple 211 with the flexure 205, the load forces can be transferred to the slider 203 uniformly.

The base plate 208 is used to enhance structure stiffness of the whole suspension 290 and may be made of rigid material such as stainless steel. A mounting hole 213 is formed on one end of the base plate 208 for mounting the whole suspension 290 to a motor arm of a disk drive.

The hinge 207 has a mounting hole 210 formed on its one end corresponding to the mounting hole 213 of the base plate 208, and the hinge 207 is partially mounted to the base plate 108 with the mounting holes 210, 213 aligned with each other. The hinge 207 and the base plate 208 may be mounted together by laser welding at a plurality of pinpoints 209 distributed on the hinge 207. In addition, two hinge steps 215 may be integrally formed at two sides of the hinge 107 at one end adjacent the mounting hole 210 for strengthening stiffness of the hinge 207. Two hinge struts 214 are extended from the other end of the hinge 207 to partially mount the hinge 207 to the load beam 206.

The flexure 205 is made of flexible material and runs from the hinge 207 to the load beam 206. The flexure 205 has a proximal end 219 adjacent the hinge 207 and a distal end 218 adjacent the load beam 206. A locating hole 217 is formed on the distal end 218 of the flexure 205 and is aligned with the locating hole 212 of the load beam 206. The perfect alignment between the locating holes 217 and 212 can assure a high assembly precision between the flexure 205 and the load beam 206. A suspension tongue 216 is provided at the distal end 218 of the flexure 205 to support the slider 203 thereon.

Now referring to FIG. 2a, a more detailed structure of the flexure 205 is shown. As illustrated, a plurality of suspension traces 220 is formed on the flexure 205 along length direction thereof. One end of the traces 220 is electrically connected to a preamplifier (not shown), and the other end thereof extends into the suspension tongue 216. When the slider 203 is mounted on the suspension tongue 216 and electrically coupled with the other ends of the traces 120, the preamplifier will control the slider 203, and further control realizing data reading/writing operation of the slider 203 with respect to a disk. The suspension tongue 216 is connected to a pair of cross bars 222 extending from two lateral sides thereof respectively. The cross bars 222 are further connected to a pair of struts 221 respectively, which are formed at distal end of the flexure 205.

The suspension tongue 216 has a leading edge limiter 223 provided at one end thereof and a trailing edge limiter 224 provided at the other end thereof for stably holding the slider 203 on the suspension tongue 216. A pair of grounding pads 225 is provided on the suspension tongue 216 adjacent the leading edge limiter 223 for effectively conducting static electricity to ground, thus preventing ESD (electric static discharge) problem. A slot 254 is formed on the suspension tongue 216 adjacent the trailing edge limiter 224. The slot 254 allows the slider, and more specifically, the magnetic transducers thereof to be electrically coupled to a plurality of electrical bonding pads 255 provided on a backside of the suspension tongue 216. Filets such as filets 253 are formed between a base portion (not labeled) of the suspension tongue 216 and the respective cross bars 222. Also, filets 251 are formed between the trailing edge limiter 224 of the suspension tongue 216 and the respective cross bars 222. These filets 253, 251 enhance the connection stiffness between the suspension tongue 216 and the cross bars 222, thereby making the whole suspension 290 more strong in structure.

For absorbing thermal deformation of the suspension tongue 216 caused by ambient temperature change, a partially hollowed stress-absorbing structure is formed on the suspension tongue 216. More specifically, as shown in FIG. 2a, two pairs of notches 252, 257 are defined on perimeter of the suspension tongue 216. The two notches 257 are located at positions adjacent the grounding pads 225, while the two notches 252 are located at central positions between the leading edge limiter 223 and the trailing edge limiter 224. In addition, two cutouts 256 are defined inside the suspension tongue 216. Each cutout 256 comprises two straight portions 271 and a curved portion 272 to interconnect the two straight portions 271. When ambient temperature changes, for example the temperature rises or decreases drastically, expansion or contraction stress will be generated inside the suspension tongue 216, and the stress will make the suspension tongue 216 expand or contract severely; however, due to existence of the notches/cutouts, the expansion or contraction stress will be absorbed or counterbalanced by deformation of the notches/cutouts; resultantly, these notches/cutouts will be deformed, but the profile of entire suspension tongue 216 will still be maintained originally. Therefore, original position and profile of the slider mounted on the suspension tongue 216 will also be maintained, and correspondingly, the flying height of the slider will be kept unchanged, thus maintaining a good flying performance for the slider.

For uniformly and quickly absorbing the stress generated in the suspension tongue 216, the number and/or positions of the notches/cutouts may be optimized. For example, the number of the notches/cutouts may be two or even more for quickly absorbing the stress and being able to absorb a larger stress. However, with increase of the notches/cutout, entire stiffness of the suspension tongue 216 may be degraded clearly; therefore, when increasing number of the notches/cutouts, the stiffness of the suspension tongue 216 must be considered reasonably.

Preferably, the two notches for example notches 257 or 252 are symmetrical about a centerline of the suspension tongue 216 along length (longitudinal) direction thereof. The symmetrical distribution also helps to evenly absorb the stress. In addition, the curved portion portions 272 of the respective cutouts 256 may be symmetrical about a position of the suspension tongue 216 corresponding to a center of the slider being mounted. This symmetrical design assists in absorbing stress of different directions, thus reducing or preventing deformation of the suspension tongue 216. Also, the curved portion 272 makes the area of the cutout 256 increased greatly, and therefore the cutout 256 can effectively absorb stresses generated due to temperature change. Though in the embodiment, two notches and two cutouts are formed on the suspension tongue, the suspension tongue may only have one notch or cutout, and similar effect will also be achieved.

Now stress-absorbing effect of the suspension tongue of the invention is illustrated. FIGS. 3a, 4a and 5a show partial views of a conventional HGA 100 and corresponding disk 101; and FIGS. 3b, 4b and 5b show partial views of a HGA 200 incorporating a flexure 205 of the invention and corresponding disk 201. In above figures, crown represents deformation of a slider in its thickness direction; Ft represents targeted flying height of the slider with respect to the disk, and Fd means variation value in slider flying height. As shown in FIGS. 3a, 4a and 5a, a slider 103 is mounted on a flexure 105, a dimple 111 of a load beam 106 engages the flexure 105, and a disk 101 is disposed below the slider 103. Since no stress-absorbing structure is provided on the flexure 105, the slider 103 endures a big profile deformation due to ambient temperature change. Namely, the slider 103 has a big deformation (crown1) in its thickness direction. This big deformation makes the slider 103 has a very big Fd value (with respect to Fd), and as shown in FIG. 5a, the big crown deformation of the slider 103 and the big Fd value causes a strong turbulent airflow 180 between the slider 103 and the spinning disk 101 during operation. All these negative facts determinate flying performance of the slider 103 and further read/writing performance thereof. Comparably, as shown in FIGS. 3b, 4b and 5b, the slider 203 mounted on the flexure 205 of the invention has a smaller deformation (crown2) in its thickness direction, as the flexure 205 has stress-absorbing structure formed thereon, which absorbs the stress generated due to temperature change. The smaller deformation of the slider 203 in thickness means that the variation in flying height (Fd, with respect to Ft) is smaller, and correspondingly, the slider 203 will fly more stably, thus maintaining a good reading/writing performance. Correspondingly, since the slider 203 has a smaller Fd value and crown deformation, as shown in FIG. 5b, airflow 280 between the slider 203 and the spinning disk 201 is nonturbulent.

Flying parameters, such as pitch static attitude and slider crown change of a slider mounted on a prior art suspension and of a slider mounted on the suspension of the invention are simulated and tested by certain equipment. The modeling results are tabulated as follows:

| Change | Prior art | Present invention |
|---|---|---|
| Pitch Static | 6.8 | 4.7 |
| Attitude(uNm) | | |
| Slider crown | 1.6 | 0.4 |
| change(um) | | |

As can be seen from this table, the slider involved in the invention yields small slider pitch static attitude and slider crown change, especially significantly for slider ABS profile change. This makes the slider have a more stable flying performance under different temperature conditions.

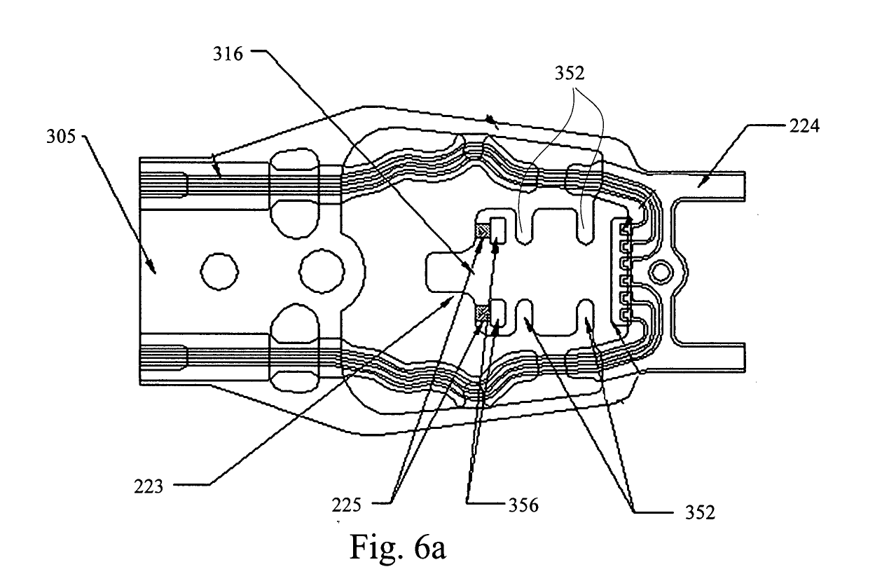

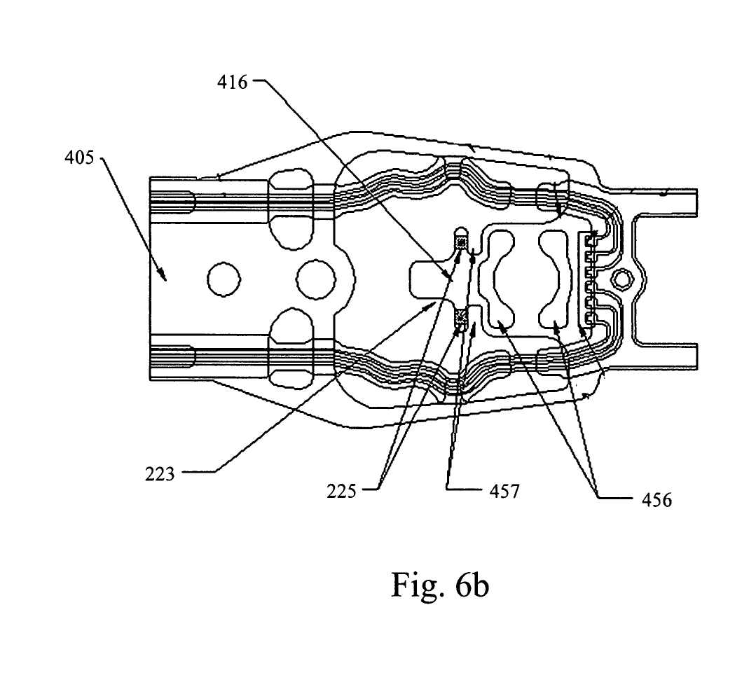

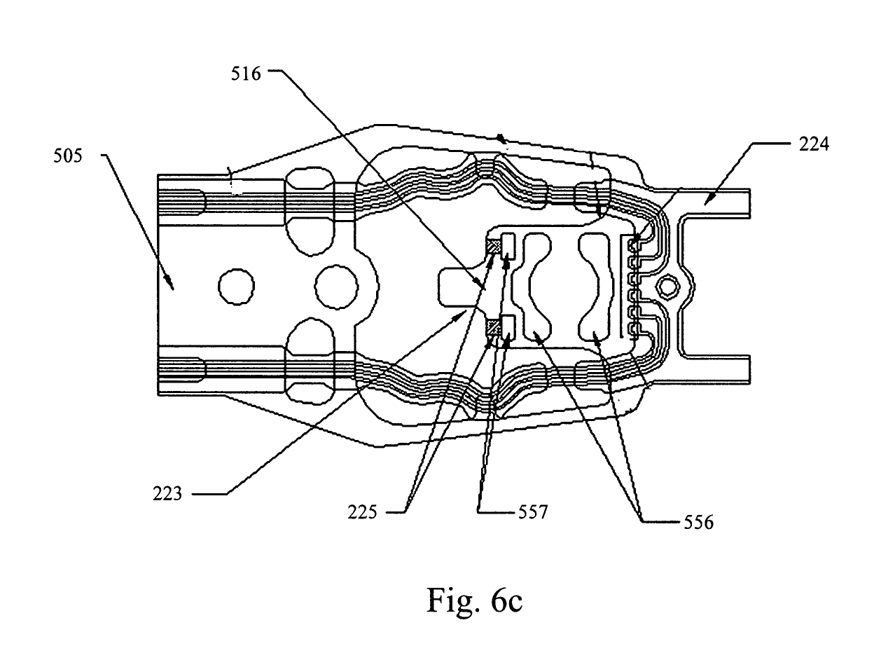

FIGS. 6a-6c show modified embodiments of the invention. As shown in FIG. 6a, the flexure 305 is similar to the flexure 205 described above. In this embodiment, a pair of cutouts 356 are formed at the leading edge limiter 223 adjacent the two grounding pads 225 of the suspension tongue 316. The cutouts 356 take a rectangular shape for sufficiently absorbing stress generated at the grounding pads 225. For uniformly absorbing the stress, the two cutouts 356 may be symmetrical about a centerline of the suspension tongue 316, the centerline being parallel to the length direction of the flexure 305. Two pairs of notches 352 are formed at perimeter of the suspension tongue 316. One pair of notches 352 is located at the trailing edge limiter 224, and the other pair of notches 352 is located at the leading edge limiter 223. This type of arrangement and shape of notches/cutouts can also gain advantageous effect similar to the flexure 205.

As shown in FIG. 6b, the flexure 405 is similar to the flexure 205, but in this embodiment, only a pair of notches 457 are formed at the leading edge limiter 223 adjacent the grounding pads 225 of the suspension tongue 416. Also, the cutouts 456 each have a bigger area than the cutouts 256 of the flexure 205. This arrangement and shape of notches/cutouts can also gain advantageous effect similar to the flexure 205.

FIG. 6c shows another flexure of the invention. In the embodiment, the flexure 505 is similar to the flexure 405. A pair of cutouts 556 are formed at the trailing edge limiter 224 of the suspension tongue 516 and another pair of cutouts 557 of rectangular shape are formed at the leading edge limiter 223 adjacent the grounding pads 225. This arrangement and shape of notches/cutouts can also gain advantageous effect similar to the flexure 205.

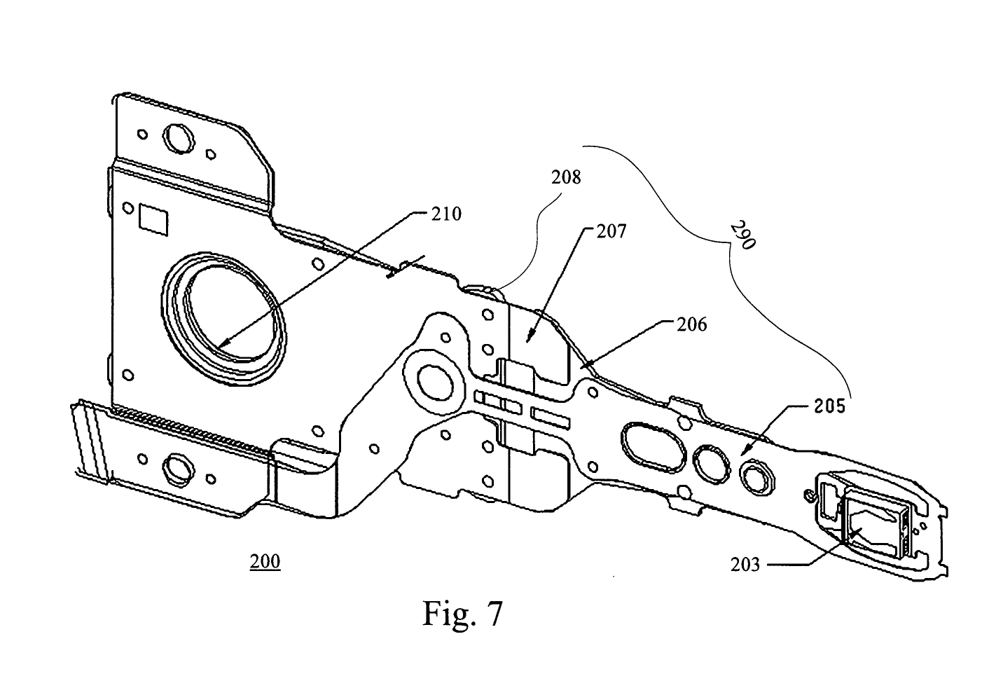

Now, referring to FIG. 7, a HGA 200 according to an embodiment of the invention comprises a suspension 290 and a slider 203 carried on the suspension 290. The suspension 290 comprises a load beam 206, a base plate 208, a hinge 207 and a flexure 205, all of which are assembled with each other. The hinge 207 has a mounting hole 210 formed thereon to assembly the hinge 207 to the base plate 208. The slider 203 is carried on the flexure 205. It is noted that the flexure may also be flexure 305, 405 or 505 of the embodiments described above.

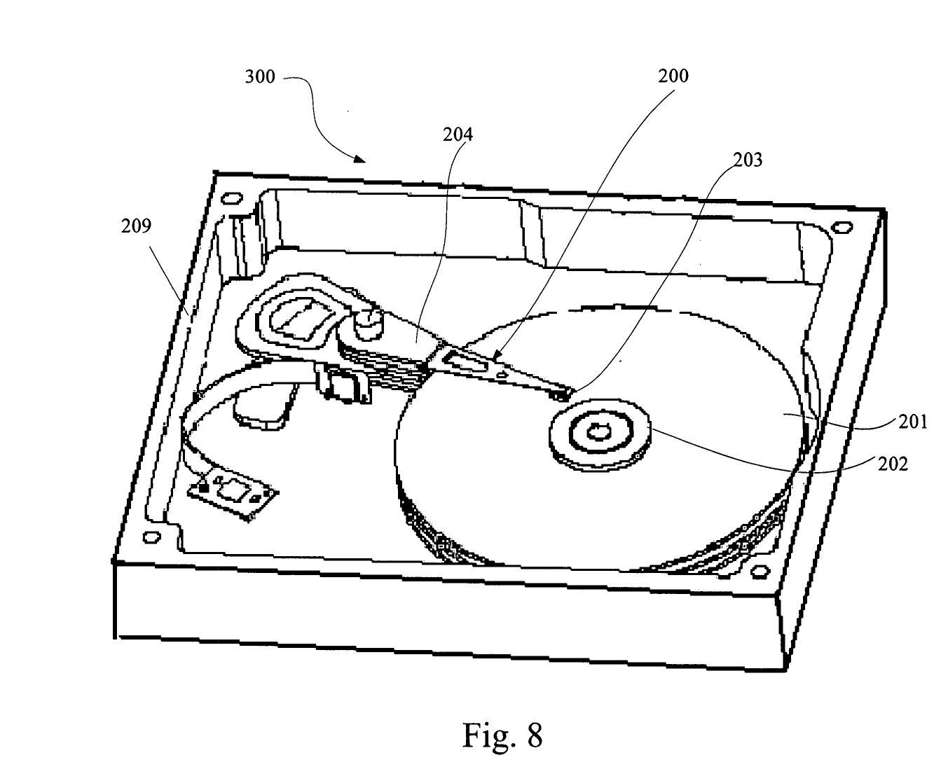

FIG. 8 shows a disk drive unit according to an embodiment of the invention. The disk drive unit 300 comprises a HGA 200, a drive arm 204 connected to the HGA 200, a disk 201, and a spindle motor 202 to spin the disk 201, all of which are mounted in a housing 209. Because the structure and/or assembly process of disk drive unit of the present invention are well known to persons ordinarily skilled in the art, a detailed description of such structure and assembly is omitted herefrom.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A suspension for a head gimbal assembly, comprising:
a flexure having a suspension tongue for mounting a slider thereon; wherein
the suspension tongue has at least one stress absorbing structure for absorbing stress generated on the suspension tongue.

2. The suspension according to claim 1, wherein the stress absorbing structure is a partially hollowed structure.

3. The suspension according to claim 2, wherein the stress absorbing structure is a notch formed on perimeter of the suspension tongue.

4. The suspension according to claim 3, wherein at least one stress absorbing structure are a plurality of notches which are symmetrical about a longitudinal centerline of the suspension tongue.

5. The suspension according to claim 3, wherein the notch extends along a horizontal direction of the suspension tongue.

6. The suspension according to claim 2, wherein the stress absorbing structure is a cutout formed in the suspension tongue.

7. The suspension according to claim 6, wherein the cutout has a curved portion for improving stress-absorbing performance of the suspension.

8. The suspension according to claim 6, wherein at least one stress absorbing structure are a plurality of cutouts which are symmetrical about a position of the suspension tongue corresponding to a center of the slider being mounted.

9. The suspension according to claim 6, wherein at least one stress absorbing structure are a plurality of cutouts which are symmetrical about a longitudinal centerline of the suspension tongue.

10. A head gimbal assembly, comprising:
a suspension, comprising a flexure having a suspension tongue for mounting a slider thereon; wherein the suspension tongue has at least one stress absorbing structure for absorbing stress generated on the suspension tongue; and
a slider disposed on the suspension tongue of the flexure of the suspension.

11. The head gimbal assembly according to claim 10, wherein the stress absorbing structure is a partially hollowed structure.

12. The head gimbal assembly according to claim 11, wherein the stress absorbing structure is a notch formed on the perimeter of the suspension tongue.

13. The head gimbal assembly according to claim 11, wherein the stress absorbing structure is a cutout.

14. A disk drive unit, comprising:
a head gimbal assembly including a slider and a suspension that supports the slider;
a drive arm connected to the head gimbal assembly;
a disk; and
a spindle motor operable to spin the disk; wherein
the suspension comprising
a flexure having a suspension tongue for mounting the slider thereon; wherein
the suspension tongue has at least one stress absorbing structure for absorbing stress generated on the suspension tongue.

15. The disk drive unit according to claim 14, wherein the stress absorbing structure is a partially hollowed structure.
